(19) United States
(12) Patent Application Publication
(10) Pub. No.: US 2005/0014501 A1
(43) Pub. Date: Jan. 20, 2005

(54) Delivery of broadcast information to a mobile station in a radio communication system

(76) Inventors: Gary John Aitkenhead, Bramley (GB); Grant Emberson, Basingstoke (GB); Lynette Lobo, Ontario (CA)

Correspondence Address: MOTOROLA, INC., 1303 EAST ALGONQUIN ROAD, IL01/3RD, SCHAUMBURG, IL, 60196, US

(21) Appl. No.: 10/485,005

(22) PCT Filed: Jun. 3, 2002
(86) PCT No.: PCT/EP02/06066

(30) Foreign Application Priority Data
Jul. 27, 2001 (GB) 0118355.7

(51) Int. Cl. H04Q 7/20

(52) U.S. Cl. 455/435.1; 455/445; 455/432.1

(57) ABSTRACT

A method (300) of delivering broadcast information to a mobile station (12) in a radio communication system (100) having a plurality of communication cells that are able to serve said mobile station (12) with a communication link. The method includes the steps of receiving a broadcast information trigger (310) caused by the mobile station; and transmitting (324), in response to receiving said trigger (310), broadcast information to the mobile station (112).

### FIELD OF THE INVENTION

This invention relates to improved delivery of broadcast information in a radio communication system. The invention is applicable to, but not limited to, delivery of neighbour cell information.

### BACKGROUND OF THE INVENTION

Wireless communication systems, for example cellular telephony or private mobile radio communication systems, typically provide for radio telecommunication links to be arranged between a plurality of base transceiver stations (BTSs) and a plurality of subscriber units, often termed mobile stations (MSs). The term mobile station generally includes both hand-portable and vehicular mounted ‘mobile’ radio units.

The communication link from a BTS to an MS is generally referred to as a down-link communication channel. Conversely, the communication link from a MS to a BTS is generally referred to as an up-link communication channel.

Wireless communication systems are distinguished over fixed communication systems, such as the public switched telephone networks (PSTN), principally in that mobile stations move between service providers (and/or different BTS) and in doing so encounter varying radio propagation environments.

In a wireless communication system, each BTS has associated with it a particular geographical coverage area (or cell). The coverage area defines a particular range that the BTS can maintain acceptable communications with MSs operating in its serving cell. Often these cells combine to produce an expanded system coverage area, with the infrastructure supporting respective cells interconnected via centralised switching equipment. Furthermore, cells are often grouped into location areas for the purposes of tracking a MS within the coverage area, whilst minimising location-updating signalling.

Mobile cellular and trunked radio systems typically allocate a broadcast information radio channel that is used to provide general system information to all mobile stations within coverage area of the system. Within such broadcast channels, each of the base transceiver stations broadcast information pertinent to the cell that they serve, as well as information about neighbouring cells. The serving and neighbour cell information is then used by mobile stations receiving the information to select the optimum cell for access to the system.

Radio frequency (RF) resources, such as bandwidth, are generally limited. Transmission of broadcast information on a signalling channel, clearly takes up bandwidth that could be used for other control channel signalling and user traffic. As the broadcast channel is generally allocated a limited resource, it is desirable to optimise the use of that resource, i.e. bandwidth, available for broadcast information.

It is known that neighbour cell information is sent periodically by each base transceiver station on the main control channel (MCCH) and may also be sent on the associated signalling channel (ACCH) on a trunked radio communication system. The MCCH is monitored by MSs whilst in idle mode, and the ACCH is monitored when MSs are communicating on assigned traffic channels in a call. Generally the base tranceiver station sends information about all of its neighbour cells in one or more downlink messages as a background low-priority task, i.e. when the BTS has little other information to transmit.

Such a periodic broadcast transmission strategy can result in MSs not receiving information about its neighbour cells in an acceptable time period. This is particularly the case for those MSs involved in a call on the traffic channel where broadcast channel bandwidth is particularly scarce. Such delays have been known to result in dropped calls or link failure. Furthermore, such an unregulated broadcast transmission strategy can also result in transmitting broadcast information at times when no MSs actually need the information. Thus, this strategy wastes valuable bandwidth that could have been better used for control signalling or user traffic.

In summary, the inventors of the present invention have recognised that the known prior art in the field of private mobile radio systems uses periodic delivery of neighbour cell information without regard to whether a particular MS is present or whether the MS wishes to receive the information.

A need therefore exists for delivery of broadcast information, particularly broadcast neighbour cell information, to MSs in radio communication systems wherein the abovementioned disadvantages may be alleviated.

Published US patent U.S. Pat. No. 5,289,525 describes a cellular radiotelephone network of the prior art. Hand-over of a call is described.

### STATEMENT OF INVENTION

In accordance with a first aspect of the present invention there is provided a method of delivering broadcast information to a mobile station, as claimed in claim 1. In accordance with a second aspect of the present invention there is provided a communication system, as claimed in claim 14. In accordance with a third aspect of the present invention there is provided a communication system, as claimed in claim 17. In accordance with a fourth aspect of the present invention there is provided a mobile station, as claimed in claim 18. In accordance with a fifth aspect of the present invention there is provided a storage medium storing processor-implementable instructions for controlling one or more processors, as claimed in claim 20. Further aspects of the invention are provided in the dependent claims.

### BRIEF DESCRIPTION OF THE DRAWINGS

Exemplary embodiments of the present invention will now be described, with reference to the accompanying drawings, in which:

FIG. 1 shows a block diagram of a trunked radio communication system adapted to support the various inventive concepts of a preferred embodiment of the present invention;

FIG. 2 shows a block diagram of a radio communication unit adapted to support the various inventive concepts of the preferred embodiment of the present invention; and

FIG. 3 shows a flowchart depicting a delivery mechanism for delivering neighbour cell information in the communication system, in accordance with the preferred embodiment of the present invention.

### DESCRIPTION OF PREFERRED EMBODIMENTS

This invention proposes a number of methods to optimise transmission of broadcast information, in particular neighbour cell information, such that a mobile station receives the information when the MS needs it. In this manner, the methods prevent unnecessary transmission of broadcast information using bandwidth that could be utilised for other purposes.

In particular, this invention proposes using trigger mechanisms in the infrastructure to initiate transmission of neighbour cell information to one or more MS(s), in contrast to periodically transmitting the information regardless of whether or not the information is needed.

The trigger mechanism in the infrastructure is responsive to the mobile station. In each method, an event involving the MS or an action by the MS provides the actuating stimulus to the trigger mechanism.

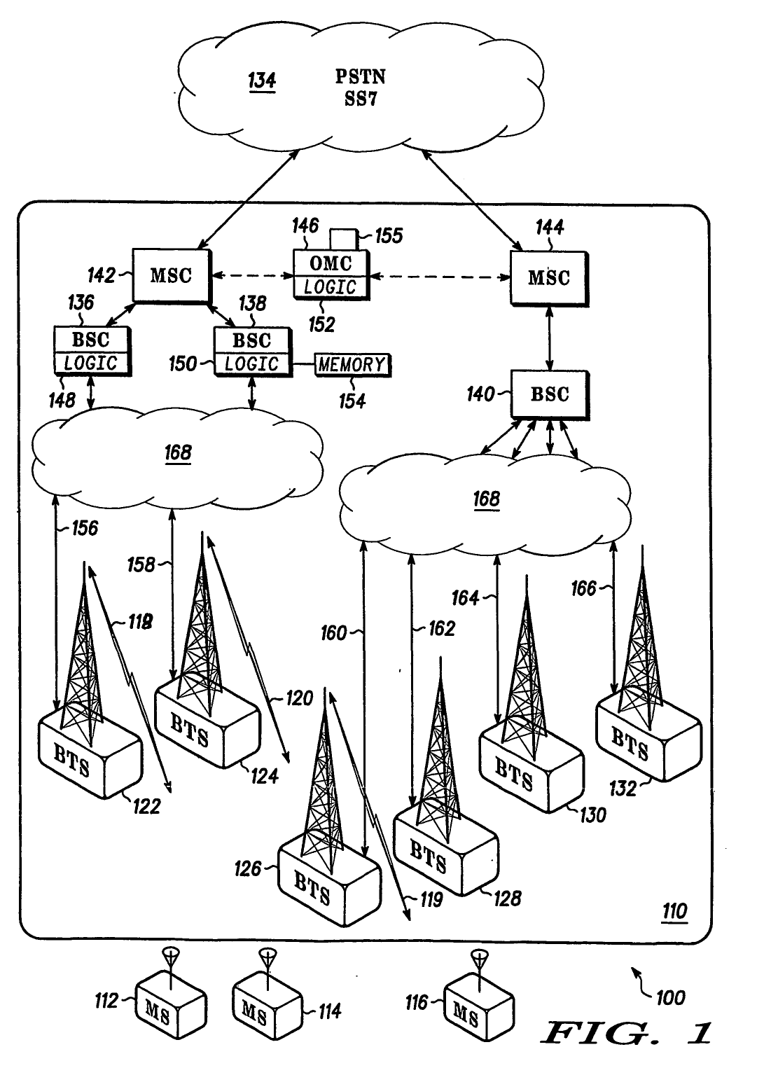

Referring first to FIG. 1, a trunked radio communications system 100, supporting a TErrestrial Trunked RAdio (TETRA) air-interface is shown, in outline, in accordance with a preferred embodiment of the invention. The TETRA air-interface has been defined by the European Telecommunications Standards Institute (ETSI). Generally, the air-interface protocol is administered from base transceiver sites that are geographically spaced apart—one base site supporting a cell (or, for example, sectors of a cell).

A plurality of subscriber units, such as a mixture of MSs 112-116 and fixed terminals (not shown), communicate over the selected air-interface 118-120 with a plurality of base transceiver stations (BTS) 122-132. A limited number of MSs 112-116 and BTSs 122-132 are shown for clarity purposes only.

The system infrastructure in a TETRA system is generally referred to as a switching and management infrastructure (SwMI) 110, which substantially contains all of the system elements apart from the MSs 112-116. The BTSs 122-132 may be connected to a conventional public-switched telephone network (PSTN) 134 through base station controllers (BSCs) 136-140 and mobile switching centres (MSCs) 142-144.

Each BTS 122-132 is principally designed to serve its primary cell, with each BTS 122-132 containing one or more transceivers. The BTSs 122-132 communicate 156-166 with the rest of the trunking system infrastructure via a frame relay interface 168.

Each BSC 136-140 may control one or more BTSs 122-132, with BSCs 136-140 generally interconnected through MSCs 142-144. Each BSC 136-140 is therefore able to communicate with one another, if desired, to pass system administration information therebetween. The BSCs 136-140 are responsible for establishing and maintaining control channel and traffic channels to serviceable MSs 112-116 affiliated therewith. The interconnection of BSCs 136-140 therefore allows the trunked radio communication system to support handover of the MSs 112-116 between cells.

Each MSC 142-144 provides a gateway to the PSTN 134, with MSCs 142-144 interconnected through an operations and management centre (OMC) 146 that administers general control of the trunked radio system 100, as will be understood by those skilled in the art. The various system elements, such as BSCs 136-138 and OMC 146, will include control logic 148-152, with the various system elements usually having associated memory 154 (shown only in relation to BSC 138 for the sake of clarity). The memory 154 typically stores historically compiled operational data as well as in-call data, system information, control algorithms and neighbour cell information.

In addition to administering general control of the trunked radio system 100, in accordance with the preferred embodiment of the invention, the OMC 146 contains a trigger response function 155.

In operation, in accordance with the preferred embodiment of the invention, the OMC 146 has been adapted to incorporate the trigger response function 155 and transmit neighbour cell information to MS(s) within particular cells upon receiving a neighbour cell information trigger.

The neighbour cell information trigger can be initiated in any of the following scenarios:

First Embodiment

In accordance with a first embodiment of the present invention, a neighbour cell information trigger is initiated when a MS, say MS 112, performs a seamless handover between cells, i.e. moves from a traffic channel on one cell to a traffic channel on another cell. In this case, the new cell may detect the arrival of the MS 112. The detection may be as a result of exchanging signalling information with the MS 112, or simply detecting uplink transmission of traffic on the traffic channel.

The trigger response function 155 of the OMC 146 associated with the new cell can use this detection as a trigger to send neighbour cell information to that MS 112 as quickly as possible. In particular, neighbour cell information can be sent to any MS that is recognised as having just arrived on the cell, but also recognised, or known, as not having up-to-date neighbour cell information.

Second Embodiment

In accordance with a second embodiment of the present invention, a neighbour cell information trigger can be initiated when a MS 112 registers with a cell, for example on the main control channel (MCCH). The trigger response function 155 of the OMC 146 associated with the cell can use this event as a trigger to broadcast neighbour cell information on the MCCH, recognising that there is at least one new MS 112 that does not have up-to-date neighbour cell information.

If the MS 112 then restores an ongoing call before receiving the neighbour cell broadcast information, which could happen if the MS 112 has registered as a result of drop-and-reconnect handover, the new cell shall then broadcast neighbour cell information to the MS 112 on the traffic channel for the restored call. In this case, the new cell may cancel transmission of the broadcast neighbour cell information on the main control channel, since the MS 112 has subsequently moved to a traffic channel.

Third Embodiment

In accordance with a third embodiment of the present invention, a neighbour cell information trigger can be initiated if a MS 112 arrives at a cell and has not received neighbour cell information within a pre-defined time period. Furthermore, or in the alternative, the MS may detect that serving cell conditions are deteriorating such that neighbour cell information is needed. The pre-defined time period managed by the trigger response function 155 may be variable depending on whether the MS 112 is in a call or not. If the MS 112 has not received neighbour cell information, initiated by the trigger response function 155 of the OMC 146, within a pre-defined time period, the MS 112 may conclude that there has been a transmission failure. The MS 112 may then request the new cell to transmit the neighbour cell information by transmitting a signalling message on an uplink resource.

In this way, the OMC 146 in the SWMI 110 can transmit neighbour cell information only in response to triggers, defined as above in any of the three embodiments, or as a result of an explicit request from a MS. The ability of a MS 112 to request the information effectively provides a repeat mechanism to compensate for times when broadcast transmissions are unreliable, i.e. the MS 112 does not acknowledge receipt and the BTS 122 does not repeat the broadcast.

Furthermore, it is within the contemplation of the invention that the speedy delivery of neighbour cell information may use techniques such as stealing, as defined in the TETRA standard. ‘Stealing’, in this context, incorporates ‘hijacking’ transmission slots or frames to transmit higher priority information.

Such a strategy also ensures that the MS 112 can start neighbour cell scanning and, if appropriate, perform cell re-selection quickly if signal conditions are changing rapidly. Advantageously, speedy cell re-selection optimises communication resources within the network.

In addition, by implementing any or all of the aforementioned embodiments, the inventors have recognised that periodic broadcasting of information will, or at least may in certain circumstances, no longer be required. In such a case, the system relies upon sending information only in response to a trigger. This means that no broadcast information needs to be sent to MS(s) if the information does not change and there is a low level of MS mobility within the cell.

It is within the contemplation of the invention that the broadcast information may be sent as a broadcast to all MS, within the coverage area of a cell, even though the trigger may emanate only from one particular MS. In this case, all MS listening to the broadcast information gain the benefit of receiving the information.

Preferably, when transmitting neighbour cell information to a MS 112, the OMC 146 ranks the neighbour cells in order of handover likelihood for a respective MS 112. Using this method, the OMC 146 may first send broadcast information about those cells immediately adjacent to the serving cell when it receives a trigger to send broadcast information.

Subsequently, it could send information about the other cells further from the serving cell that would be less likely candidates for handover.

It is within the contemplation of the invention that this method could be further enhanced if the MS 112 includes its precise location in the registration message. The precise location may be obtained via a global positioning system (GPS) unit or some other such method, for example a MS 112 or system or combined time of arrival and angle of arrival or triangulation methods, as known in the art of cellular system design.

The primary objective is to transmit neighbour cell information as fast as possible for those cells to which the MS 112 is closest. In this manner, the MS 112 can initiate RP measurements and build a list of candidate cells for subsequent handover. This additional method further enhances this aspect of the invention whilst minimising transmission bandwidth.

A yet further enhancement to the above mechanism allows for the OMC 146 of the SwMI 110 to include second tier neighbour cells, for example additional neighbours to the serving cell's immediate adjacent neighbours, as required. The selection of second tier neighbour cells is preferably based on a knowledge of the mobile's location and knowledge of the terrain. In some cases, a more distant site may actually provide better coverage in a small area that is shadowed by say, a hill or building.

Using this method, if the distant site was included in the neighbour list, the MS 112 could be handed over to the more distant cell in the area. This method provides a higher level of sophistication in ranking neighbour cells in order of handover likelihood for an MS 112 taking into account terrain and obstacles.

In the context of the present invention, the BTS has been adapted to respond to the trigger response function 155 of the OMC 146. However, it is within the contemplation of the invention that the trigger response function 155, and decision-making processes associated therewith, may be incorporated into a MSC, BSC or BTS. Alternatively, such functions and processes may be distributed between a number of such infrastructure elements in the system architecture.

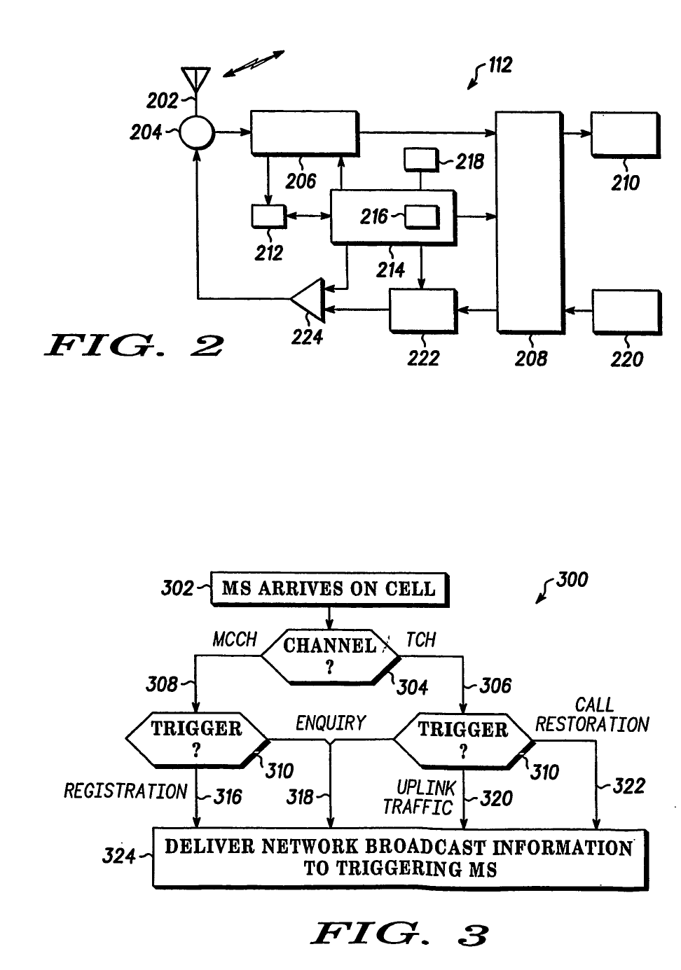

Referring now to FIG. 2, a block diagram of a subscriber unit/mobile station (MS) 112 adapted to support the inventive concepts of the preferred embodiments of the present invention is shown.

The MS 112 contains an antenna 202 preferably coupled to a duplex filter or circulator 204 that provides isolation between receive and transmit chains within MS 112.

The receiver chain includes scanning receiver front-end circuitry 206 (effectively providing reception, filtering and intermediate or base-band frequency conversion). The scanning front-end circuit 206 scans signal transmissions from its associated BTS and perhaps any direct-mode (DM) call set-up messages from other MS in its talk group. The scanning front-end circuitry 206 is serially coupled to a signal processing function (processor, generally realised by a DSP) 208.

In accordance with a preferred embodiment of the invention, the receiver chain 210, in particular the signal processing function 208, coupled to the scanning front-end circuit 206, has been adapted for a receiving MS to receive and process messages, such as neighbour cell information, sent by the trigger response function 155. In this manner, the MS 112 can start neighbour cell scanning and, if appropriate, perform cell re-selection quickly if the prevailing signal conditions justify cell re-selection.

In accordance with the second embodiment of the invention, in the situation, for example, where the MS 112 restores an ongoing call before receiving any neighbour cell broadcast information, the signal processor and scanning front-end circuitry 206 have been adapted to receive broadcast neighbour cell information on the traffic channel for the restored call. In this case, the MS 112 will not scan the MCCH for a transmission of the broadcast neighbour cell information, thereby saving time and processor power.

A controller 214 is operably coupled to the scanning front-end circuitry 206 so that the receiver can calculate receive bit-error-rate (BER) or frame-error-rate (FER) or similar link-quality measurement data from recovered information via a received signal strength indication (RSSI) 212 function. The RSSI 212 function is operably coupled to the scanning front-end circuit 206. The memory device 216 stores a wide array of MS-specific data, such as decoding/encoding functions, neighbour and serving cell information relating to timing, frequency channels, power control and the like, as well as link quality measurement information to enable an optimal communication link to be selected.

A timer 218 is operably coupled to the controller 214 to control the timing of operations, namely the transmission or reception of time-dependent signals, within the MS 112. As known in the art, received signals that are processed by the signal processing function are typically input to an output device 210, such as a speaker or visual display unit (VDU).

In the context of the preferred embodiment of the present invention, timer 218 is used to synchronize the MS 112 to the timing dictated by the SWMI 110, in particular to receive, or request, a neighbour cell transmission. Furthermore, the timer 218 enables the MS 112 to respond to such early transmission of neighbour cell information quickly.

As regards the transmit chain, this essentially includes an input device 220, such as a microphone, coupled in series through the signal processor 208, transmitter/modulation circuitry 222 and a power amplifier 224. The processor 208, transmitter/modulation circuitry 222 and the power amplifier 224 are operationally responsive to the controller, with an output from the power amplifier coupled to the duplex filter or circulator 204, as known in the art.

The transmit chain in MS 112, particularly with regard to the third embodiment of the present invention, has been adapted to request a new serving cell to transmit the neighbour cell information. Such a request is made by transmitting a signalling message on the uplink.

The reqest may be initiated if the MS. 112 has not received neighbour cell information, within a pre-defined time period, resulting in the MS 112 concluding that there had been a transmission failure.

Furthermore, the MS 112 may request the broadcast information to be transmitted in response to the MS 112 recognising a deterioration in signal conditions. In such a manner, the MS has recognised that in order to continue with a communication, the MS may need to find an alternative BTS/communication provider. Consequently, the MS needs to be informed of suitable neighbouring cells.

The signal processor function 208 in the transmit chain may be implemented as distinct from the processor in the receive chain. Alternatively, a single processor 208 may be used to implement the processing of both transmit and receive signals, as shown in FIG. 2.

Of course, the various components within the MS 112 can be realised in discrete or integrated component form. Furthermore, it is within the contemplation of the invention that MS 112 may be one of a mobile phone, a portable or mobile PMR radio, a personal digital assistant, a lap-top computer or a wirelessly networked PC that requires access to the communication system.

More generally, the trigger response function 155 and processes associated therewith may be implemented in a respective communication unit in any suitable manner. For example, new apparatus may be added to a conventional communication unit (for example OMC 146), or alternatively existing parts of a conventional communication unit may be adapted, for example by reprogramming one or more processors therein. As such the required adaptation may be implemented in the form of processor-implementable instructions stored on a storage medium, such as a floppy disk, hard disk, PROM, RAM or any combination of these or other storage multimedia.

Referring now to FIG. 3, a flowchart 300 is shown depicting a delivery mechanism for delivering neighbour cell information in a communication system, in accordance with the preferred embodiment of the present invention.

An MS arrives in a cell, see step 302. Then, the OMC 146 receives a trigger in step 304, as shown in step 310. This may be on either the MCCH, see 308, or a traffic channel (TCH), see 306.

The trigger in step 310 is initiated within the trigger response function in the infrastructure, for example within the OMC 146, in accordance with any of the aforementioned embodiments. The trigger may occur as a result of one or more of the following: a registration process in step 316, an enquiry in step 318, an up-link request from a MS in step 320, a call restoration in step 322. After the trigger has been initiated, the network broadcast information, for example neighbour and/or serving cell information, is delivered to the MS(s), as shown in step 324.

In this manner, one or more of a number of methods are used to optimise transmission of broadcast information, in particular neighbour cell information, such that a MS receives the information when the MS needs it. Advantageously, the methods prevent unnecessary transmission of broadcast information using bandwidth that could be utilised for other purposes.

In the above embodiments, the delivery of broadcast information is appropriate to the radio system described. However, it will be appreciated that alternative broadcast delivery mechanisms using a trigger-based arrangement may be applicable to other radio or fixed communication systems involving broadcast data.

The present invention finds particular application in a private mobile radio communication system such as TETRA. However, the inventive concepts contained herein are equally applicable to alternative fixed or cellular communication systems such as the Universal Mobile Telecommunications Standard (UMTS), and the Global System for Mobile communications (GSM) and any derivatives thereof.

It will be understood that the delivery of neighbour cell information to a mobile station in a radio communication system as described above provides at least the following advantages:
(i) provides a MS with neighbour cell parameters in a reasonable time period, even when in a call on a cell-site with heavy traffic load;
(ii) that periodic broadcasting of information will, or at least may in certain circumstances, no longer be required and
(iii) the transmission of neighbour cell information is optimised by detecting when a new mobile station arrives on the cell so that any transmission of broadcast information, for example periodic transmission, does not waste channel bandwidth.

Thus, a method of delivering broadcast information to a mobile station in a radio communication system, having a plurality of communication cells that are able to serve said mobile station with a communication link, has been described. The method includes the steps of receiving a broadcast information trigger caused by a mobile station; and transmitting, in response to receiving said trigger, broadcast information to the mobile station. Also, a communication system, having a plurality of communication cells that are able to serve a plurality of mobile stations with a communication link, has been described. The communication system includes a trigger response function, responsive to at least one mobile station, for generating a broadcast information trigger; and a transmitter, operably coupled to said trigger response function to broadcast information to at least one mobile station in response to said generated trigger.

In addition, a communication system, a mobile station and a storage medium storing processor-implementable instructions for controlling one or more processors to carry out any of the aforementioned method steps has been described.

Whilst specific, and preferred, implementations of the present invention are described above, it is clear that variations and modifications of such inventive concepts could be readily applied by one skilled in the art.

1. A method of delivering broadcast information to a mobile station in a radio communication system having a plurality of communication cells that are able to serve said mobile station with a communication link, the method characterised by the steps of:
receiving a broadcast information trigger caused by the mobile station; and
transmitting, in response to receiving said trigger, broadcast information to the mobile station.

2. The method of delivering broadcast information according to claim 1, wherein the broadcast information includes serving cell and/or neighbour cell information.

3. The method of delivering broadcast information according to claim 1, the method further characterised by the step of:
receiving a request from said mobile station for said broadcast information to be transmitted, wherein the request is the trigger.

4. The method of delivering broadcast information according to claim 3, wherein the mobile station requests transmission of the broadcast information in response to a deterioration in a signal condition.

5. The method of delivering broadcast information according to claim 3, wherein the mobile station transmits a request for said broadcast information after not receiving said information a pre-defined time period after moving into a cell.

6. The method of delivering broadcast information according to claim 5, wherein the pre-defined time period is variable dependent on whether said mobile station is in a call.

7. The method of delivering broadcast information according to claim 1, the method further comprising the step of:
detecting when a mobile station arrives in a cell in order to initiate said trigger.

8. The method of delivering broadcast information according to claim 7, wherein the step of detecting includes the step of:
detecting that said mobile station has performed a handover between a first cell and a second cell to initiate said trigger.

9. The method of delivering broadcast information according to claim 7, wherein the step of detecting includes at least one of the steps of:
detecting an arrival of said mobile station on a cell; or
detecting an exchange of signalling information with said mobile station, or
detecting an uplink transmission from said mobile station.

10. The method of delivering broadcast information according to claim 7, wherein the step of detecting includes the step of:
detecting a registration message of said mobile station.

11. The method of delivering broadcast information according to claim 2, the method further comprising the steps of:
ranking neighbour cell information based on a likelihood of said mobile station selecting a particular cell to move to; and
transmitting higher ranked neighbour cell information in preference to lower ranked neighbour cell information in response to the step of receiving a trigger.

12. The method of delivering broadcast information according to claim 11, the method further comprising the steps of:
obtaining an indication of said mobile station's location, for example in a registration message or in determining a location from a transmission of said mobile station using a triangulation method; and
ranking said neighbour cell information in response to said location.

13. The method of delivering broadcast information according to claim 1, wherein the transmission of broadcast information is only sent in response to a trigger.

14. A communication system having a plurality of communication cells that are able to serve a plurality of mobile stations with a communication link, the communication system comprising:
a trigger response function for generating a broadcast information trigger, the trigger response function being responsive to at least one mobile station; and
a transmitter, operably coupled to said trigger response function, to broadcast information to the at least one mobile station in response to said generated trigger.

15. The communication system according to claim 14, wherein the broadcast information includes serving cell and/or neighbour cell information.

16. The communication system according to claim 14, wherein the trigger response function is positioned in one or more of: an operations and management centre, a base transceiver station, a base station controller, a mobile switching centre.

17. A mobile station adapted to perform the method steps of claim 1.

18. A mobile station adapted to perform the method steps of claim 3.

19. The mobile station of claim 17 wherein the mobile station is a mobile phone, a portable or mobile PMR radio, a personal digital assistant, a lap-top computer or a wirelessly networked PC.

20. A storage medium storing processor-implementable instructions for controlling one or more processors to carry out the method of claim 1.
